(19) United States
(12) Patent Application Publication
(10) Pub. No.: US 2026/0181037 A1
(43) Pub. Date: Jun. 25, 2026

(54) WebRTC CONNECTION METHOD AND SYSTEM

(71) Applicant: SHANGHAI BILIBILI TECHNOLOGY CO., LTD., Shanghai (CN)

(72) Inventor: Jun LIU, Shanghai (CN)

(21) Appl. No.: 18/719,709

(22) PCT Filed: Jun. 14, 2022
(86) PCT No.: PCT/CN2022/098675

§ 371 Date: Jun. 13, 2024

(30) Foreign Application Priority Data
Dec. 14, 2021 (CN) 202111527367.5

(51) Int. Cl. H04L 67/02; H04L 65/1016; H04L 65/1046; H04L 65/1069

(52) U.S. Cl. CPC H04L 67/02; H04L 65/1016; H04L 65/1046; H04L 65/1069

(57) ABSTRACT

The present application discloses a WebRTC connection method. The method is applied to a calling device, and includes: generating a link, the link including first information for accessing the calling device; sending the link to a called device through a first application communication platform, wherein the called device obtains, in response to the link, second information for accessing the called device, and returns the second information; obtaining the second information through a second application communication platform; and establishing a WebRTC connection with the called device based on the first device-information and the second information. According to the technical solutions provided in the present application, a private signaling service may be bypassed, so that a WebRTC connection process is prevented from being recorded and tracked by the private signaling service, and privacy and security in WebRTC communication are ensured.

The present application claims priority to Chinese Patent Application No. 202111527367.5, filed on Dec. 14, 2021, and entitled “WebRTC CONNECTION METHOD AND SYSTEM”, which is incorporated herein by reference in its entirety.

### TECHNICAL FIELD

The present application relates to the field of communication, and in particular, to a WebRTC connection method and apparatus, a computer device, a computer-readable storage medium, and a WebRTC connection system.

### BACKGROUND ART

With the development of the world wide web (www) and mobile Internet, a WebRTC technology has become technical content of concern to all parties. Web real-time communication (WebRTC) is a technology for performing real-time video and audio communication inside a browser. For example, WebRTC may implement a web-based video conference. WebRTC makes direct web communication between browsers of different terminals possible, thereby changing a network structure mode in which the browser of the terminal can only pull information through a server. This is a great change to a web technology.

As shown in FIG. 1, an existing WebRTC connection establishment process is as follows. In (1), a calling device and a called device obtain their respective public network addresses and port numbers from a STUN server. In (2), the calling device and the called device exchange their respective device information (for example, the network addresses and the port numbers) through a signaling server. In (3), a peer-to-peer connection is established based on the exchanged device information.

The inventor has found that if the signaling server is a private server, the connection establishment process may be recorded and tracked.

### SUMMARY OF THE INVENTION

An objective of embodiments of the present application is to provide a WebRTC connection method and apparatus, a computer device, a computer-readable storage medium, and a WebRTC connection system, to solve the foregoing problems.

An aspect of the embodiments of the present application provides a WebRTC connection method. The method is applied to a calling device, and includes:
obtaining a link, the link including first device information for accessing the calling device;
sending the link to a called device through a first application communication platform, so that the called device obtains, in response to the link, second device information for accessing the called device, and returns the second device information;
obtaining the second device information through a second application communication platform; and
establishing a WebRTC connection to the called device based on the first device information and the second device information.

Optionally, the obtaining a link includes:
sending a page request to a CDN server that is deployed publicly, so as to obtain a page response from the CDN server; and
parsing the page response, and performing the following operations based on a parsing result:
   triggering the calling device to request the first device information from a STUN server that is deployed publicly;
   generating the link based on the first device information;
   generating an information exchange page, the information exchange page including a link entry box, a response password entry box, and a connection button;
   entering the link in the link entry box; and
   displaying the information exchange page including the entered link.

Optionally, the establishing a WebRTC connection to the called device based on the first device information and the second device information includes:
copying and pasting the second device information to the response password entry box; and
when the connection button is triggered, generating a connection request based on the link and the second device information on the information exchange page, so as to establish the WebRTC connection between the calling device and the called device.

Optionally, the first application communication platform is different from the second application communication platform.

Optionally, the sending the link to a called device through a first application communication platform includes:
copying and pasting the link on the information exchange page to the first application communication platform; and
transmitting the pasted link to the called device through the first application communication platform.

Optionally, the obtaining the second device information through a second application communication platform includes:
obtaining, through the second application communication platform, the second device information transmitted by the called device; and
copying and pasting the second device information from the second application communication platform to the response password entry box.

Another aspect of the embodiments of the present application provides a WebRTC connection apparatus. The apparatus is used in a calling device, and includes:
a first obtaining module configured to obtain a link, the link including first device information for accessing the calling device;
a sending module configured to send the link to a called device through a first application communication platform, so that the called device obtains, in response to the link, second device information for accessing the called device, and returns the second device information;
a second obtaining module configured to obtain the second device information through a second application communication platform; and
a connection establishment module configured to establish a WebRTC connection to the called device based on the first device information and the second device information.

Another aspect of the embodiments of the present application provides a WebRTC connection method. The method is applied to a called device, and includes:
obtaining, through a first application communication platform, a link sent by a calling device, the link including first device information for accessing the calling device;
opening the link through a browser, and obtaining, based on the link, second device information for accessing the called device from a STUN server that is deployed publicly;
sending the second device information to the calling device through a second application communication platform; and
establishing a WebRTC connection to the calling device based on the first device information and the second device information.

Optionally, the first application communication platform is different from the second application communication platform.

Optionally, the obtaining, through a first application communication platform, a link sent by a calling device includes:
obtaining, through the first application communication platform, the link transmitted by the calling device; and
copying and pasting the link from the first application communication platform to an address bar of the browser, so as to open the link.

Optionally, the sending the second device information to the calling device through a second application communication platform includes:
copying and pasting the second device information in the browser to the second application communication platform; and
transmitting the pasted second device information to the calling device through the second application communication platform.

Another aspect of the embodiments of the present application provides a WebRTC connection apparatus. The apparatus is used in a called device, and includes:
a first obtaining module configured to obtain, through a first application communication platform, a link sent by a calling device, the link including first device information for accessing the calling device;
a second obtaining module configured to open the link through a browser, and obtain, based on the link, second device information for accessing the called device from a STUN server that is deployed publicly;
a sending module configured to send the second device information to the calling device through a second application communication platform; and
a connection establishment module configured to establish a WebRTC connection to the calling device based on the first device information and the second device information.

Another aspect of the embodiments of the present application provides a computer device, including a memory, a processor, and computer-readable instructions stored on the memory and capable of running on the processor. When the processor executes the computer-readable instructions, the steps of the foregoing WebRTC connection method are implemented.

Another aspect of the embodiments of the present application provides a computer-readable storage medium having computer-readable instructions stored thereon. The computer-readable instructions may be executed by at least one processor to cause the at least one processor to perform the steps of the foregoing WebRTC connection method.

Another aspect of the embodiments of the present application provides a WebRTC connection system. The system includes a calling device and a called device, the calling device has a built-in first browser, and the called device has a built-in second browser.

The calling device is configured to: obtain a link through the first browser, the link including first device information for accessing the calling device, and send the link to the called device through a first application communication platform.

The called device is configured to: receive the link through the first application communication platform, open the link through the second browser, obtain, based on the link, second device information for accessing the called device, and return the second device information to the calling device through a second application communication platform.

The calling device is configured to: receive the second device information through the second application communication platform, copy and paste the second device to the first browser, and generate a connection request based on the link and the second device information in the first browser through the first browser, so as to establish a WebRTC connection between the first browser and the second browser.

Optionally, the calling device is configured to:
send, through the first browser, a page request to a CDN server that is deployed publicly, so as to obtain a page response from the CDN server; and
parse the page response, and perform the following operations based on a parsing result:
   triggering the calling device to request the first device information from a STUN server that is deployed publicly;
   generating the link based on the first device information;
   generating an information exchange page, the information exchange page including a link entry box, a response password entry box, and a connection button;
   entering the link in the link entry box; and
   displaying the information exchange page including the entered link.

Optionally, the calling device is configured to:
copy and paste the second device information to the response password entry box; and
when the connection button is triggered, generate the connection request based on the link and the second device information on the information exchange page, so as to establish the WebRTC connection between the first browser and the second browser.

Optionally,
the calling device is configured to: copy and paste the link on the information exchange page to the first application communication platform; and transmit the pasted link to the called device through the first application communication platform.

The called device is configured to: obtain, through the first application communication platform, the link transmitted by the calling device, and copy and paste the link from the first application communication platform to an address bar of the browser.

Optionally,
the called device is configured to: copy and paste the second device information in the second browser to the second application communication platform, and transmit the pasted second device information to the calling device through the second application communication platform.

The calling device is configured to: obtain the second device information through a second application communication platform, and copy and paste the second device information from the second application communication platform to the response password entry box.

Optionally, the first application communication platform is different from the second application communication platform.

The WebRTC connection method and apparatus, the device, the computer-readable storage medium, and the WebRTC connection system provided in the embodiments of the present application have the following advantages.

In a process of establishing the WebRTC connection between the calling device and the called device, information exchange (for example, the first device information and the second device information) between the calling device and the called device is implemented through the first application communication platform and the second application communication platform that serve a third party. To be specific, information exchange between the two bypasses a (private) signaling server. Therefore, the WebRTC connection process is prevented from being recorded and tracked by the (private) signaling server, and privacy and security in WebRTC communication are ensured.

### BRIEF DESCRIPTION OF THE DRAWINGS

FIG. 1 is a diagram of a WebRTC network connection architecture according to the prior art;

FIG. 2 is a diagram schematically showing a network architecture of a WebRTC connection system according to an embodiment of the present application;

FIG. 3 schematically shows an information exchange page carrying a link in a calling device;

FIG. 4 schematically shows an information exchange page in a called device;

FIG. 5 schematically shows an information exchange page including pasted second device information in a calling device;

FIGS. 6A-6B schematically show a communication interface of a calling device and a communication interface of a called device;

FIG. 7 is a flowchart schematically showing a WebRTC connection method according to Embodiment 2 of the present application;

FIG. 8 is a flowchart of substeps of step S700 in FIG. 7;

FIG. 9 is a flowchart of substeps of step S706 in FIG. 7;

FIG. 10 is a flowchart of substeps of step S702 in FIG. 7;

FIG. 11 is a flowchart of substeps of step S704 in FIG. 7;

FIG. 12 is a flowchart schematically showing a WebRTC connection method according to Embodiment 3 of the present application;

FIG. 13 is a flowchart of substeps of step S1200 in FIG. 12;

FIG. 14 is a flowchart of substeps of step S1204 in FIG. 12;

FIG. 15 is a block diagram schematically showing a WebRTC connection apparatus according to Embodiment 4 of the present application;

FIG. 16 is a block diagram schematically showing a WebRTC connection apparatus according to Embodiment 5 of the present application; and

FIG. 17 is a schematic diagram schematically showing a hardware architecture of a computer device suitable for implementing a WebRTC connection method according to Embodiment 6 of the present application.

### DETAILED DESCRIPTION OF EMBODIMENTS

To make the objectives, technical solutions, and advantages of the present application clearer and more comprehensible, the present application will be further described in detail with reference to the accompanying drawings and embodiments. It should be understood that the specific embodiments described herein are merely intended to explain the present application, and are not intended to limit the present application. All other embodiments obtained by those of ordinary skill in the art based on the embodiments of the present application without creative efforts shall fall within the protection scope of the present application.

It should be noted that the descriptions related to “first”, “second”, and the like in the embodiments of the present application are merely for the illustrative purpose, and should not be construed as indicating or implying the relative importance thereof or implicitly indicating the number of technical features indicated. Therefore, a feature defined by “first” or “second” may explicitly or implicitly include at least one such feature. In addition, technical solutions in various embodiments may be combined with each other, provided that they can be implemented by those of ordinary skill in the art. When a combination of the technical solutions incurs conflict or cannot be implemented, it should be considered that such a combination of the technical solutions does not exist, and does not fall within the claimed scope of protection of the present application either.

In the description of the present application, it should be understood that the reference numerals of steps do not indicate the order of execution of the steps, but are merely to facilitate the description of the present application and differentiation between the steps, and thus will not be interpreted as limiting the present application.

Web real-time communication (WebRTC) is a technology for performing real-time video and audio communication inside a browser. For example, WebRTC may implement a web-based video conference. WebRTC makes direct web communication between browsers of different terminals possible, thereby changing a network structure mode in which the browser of the terminal can only pull information through a server. This is a great change to a web technology.

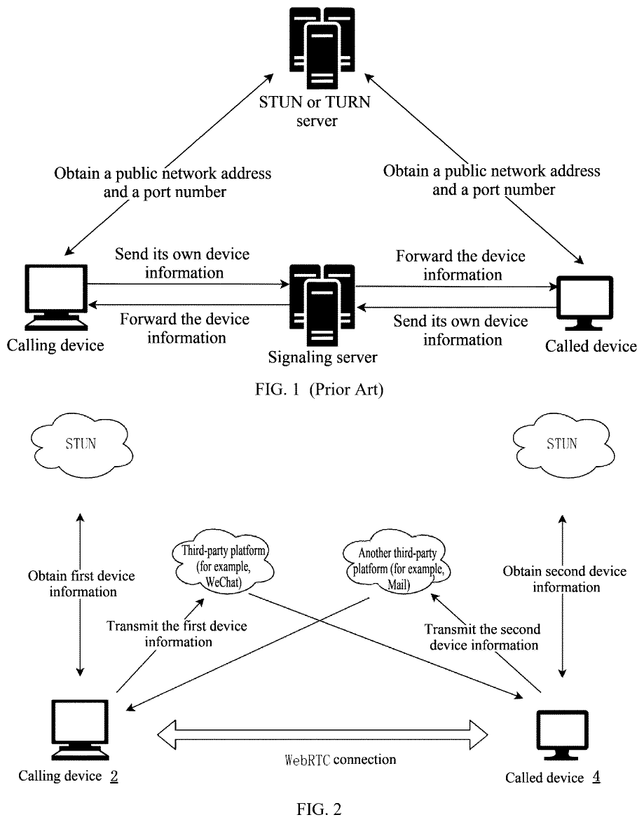

As shown in FIG. 1, an existing WebRTC connection establishment process is as follows. In (1), a calling device and a called device obtain their respective public network addresses and port numbers from a Session Traversal Utilities for NAT (STUN) server. In (2), the calling device and the called device exchange their respective device information (for example, the network addresses and the port numbers) through a signaling server. In (3), a peer-to-peer connection is established based on the exchanged device information. The inventor has found that in step (2), if the signaling server is a private server, the connection establishment process may be recorded and tracked. In step (3), the peer-to-peer connection is established, and communication content is directly sent to each other. However, when a communication portal (for example, a specific web page or a specific APP) is built by an enterprise or privately, and is not open and transparent to the public, information may still be intercepted and recorded before sent.

For the foregoing problem, the present application aims to provide a solution of establishing a peer-to-peer private connection without a private service. In this solution, an open and transparent service is used to establish a peer-to-peer (P2P) connection, and information (a text, a picture, audio, a video, or the like) is transmitted between two or more devices through Internet infrastructure. In addition, the information transmitted between the devices avoids the private service, so that communication content is prevented from being stored and traced.

Terms in the present application are explained below.

WebRTC: it is abbreviated from web real-time communication, and is a real-time communication technology. WebRTC allows network applications or sites to establish a peer-to-peer connection between browsers without an intermediate medium, to implement transmission of a video stream and/or an audio stream or any other data.

Signaling server: it is a server configured to forward messages between WebRTC clients.

Content delivery network (CDN) server: it is an edge server deployed in each region. Through function modules of a central platform for load balancing, content delivery, scheduling, and the like, the CDN server may enable a user to obtain required content nearby, to reduce network congestion and increase a user access response speed and a hit rate.

STUN server: it is configured to provide a public network address, a port number, and the like.

FIG. 2 is a diagram schematically showing a network architecture of a WebRTC connection method according to an embodiment of the present application.

A calling device 2 may be configured as a device capable of implementing a WebRTC connection. The calling device 2 may include any type of electronic device, for example, a mobile device, a tablet device, a laptop computer, or a smart television.

A called device 4 may be configured as a device capable of implementing a WebRTC connection. The called device 4 may include any type of electronic device, for example, a mobile device, a tablet device, a laptop computer, or a smart television.

The calling device 2, the called device 4, a CDN server, and a STUN server may communicate with one another through one or more networks. The one or more networks include various network devices, for example, routers, switches, multiplexers, hubs, modems, network bridges, repeaters, firewalls, and/or proxy devices. The one or more networks may include physical links, for example, coaxial cable links, twisted-pair cable links, optical fiber links, and a combination thereof, or may include wireless links, for example, cellular links, satellite links, or Wi-Fi links.

The calling device 2 and the called device 4 each are installed with a browser and a communication tool (for example, Mail, WeChat, or Forum). A WebRTC connection may be implemented through the browser to further implement an audio call or a video call, or the like. The calling device 2 and the called device 4 each are configured with a client interface. The client interface may include an input element. For example, the input element may be configured to receive a user instruction. The user instruction may implement various types of operations.

In a process of establishing a WebRTC connection between the calling device 2 and the called device 4, the calling device 2 and the called device 4 need to exchange information with each other through different first application communication platforms, so as to implement communication negotiation between the two. The information may include respective device information of the two, for example, a public network address or a port number.

Under the exemplary network architecture shown in FIG. 2, the present application provides a plurality of embodiments for WebRTC connection, which is specifically as follows.

### Embodiment 1

Continue to refer to FIG. 2. This embodiment provides a WebRTC connection system.

As shown in FIG. 2, the WebRTC connection system includes the calling device 2 and the called device 4.

The calling device 2 has a built-in first browser and also built-in communication applications such as WetChat and Mail.

The called device 4 has a built-in second browser and also built-in communication applications such as WetChat and Mail.

The calling device 2 is configured to: obtain a link through the first browser, the link including first device information for accessing the calling device, and send the link to the called device through a first application communication platform.

The first device information may include a public network address, a port number, and the like of the calling device 2.

The called device 4 is configured to: receive the link through the first application communication platform, open the link through the second browser, obtain, based on the link, second device information for accessing the called device, and return the second device information to the calling device through a second application communication platform.

The second device information may include a public network address, a port number, and the like of the called device 4.

The calling device 2 is configured to: receive the second device information through the second application communication platform, copy and paste the second device to the first browser, and generate a connection request based on the link and the second device information in the first browser through the first browser, so as to establish a WebRTC connection between the first browser and the second browser.

The WebRTC connection system provided in this embodiment of the present application has the following advantages.

In a process of establishing the WebRTC connection between the first browser and the second browser, information exchange (for example, the first device information and the second device information) between the calling device 2 and the called device 4 is implemented through the first application communication platform and the second application communication platform that serve a third party. To be specific, information exchange between the two bypasses a (private) signaling server. Therefore, the WebRTC connection process is prevented from being recorded and tracked by the (private) signaling server, and privacy and security in WebRTC communication are ensured.

The first application communication platform and the second application communication platform may be the same platform, for example, WeChat.

As an optional embodiment, the first application communication platform is different from the second application communication platform. For example, the first application communication platform is WeChat, and the second application communication platform is Mail. It should be noted that WeChat and Mail are exemplary and are not intended to limit the patent protection scope of the present application. In this embodiment, the calling device 2 and the called device 4 select different communication modes for information exchange, so that a complete information exchange process is prevented from being recorded by a same private service, and tracing difficulty is increased.

As an optional embodiment, the calling device 2 is configured to:
send, through the first browser, a page request to the CDN server that is deployed publicly, so as to obtain a page response from the CDN server; and
parse the page response, and perform the following operations based on a parsing result:
   triggering the calling device to request the first device information from the STUN server that is deployed publicly;
   generating the link based on the first device information;
   generating an information exchange page, the information exchange page including a link entry box, a response password entry box, and a connection button;
   entering the link in the link entry box; and
   displaying the information exchange page including the entered link.

In this optional embodiment, the CDN server that is deployed publicly and the STUN server that is deployed publicly are used, that is, open and transparent services are used, so that interception and tracking by the private service are further prevented. In addition, with the information exchange page, the link can be effectively guided to be transmitted to the first application communication platform.

Specifically, an open and transparent information exchange interface is deployed on the public CDN server, and the first device information is obtained through the public STUN server to provide necessary exchange, to enable the device to communicate on the interface.

As an optional embodiment, the calling device 2 is configured to:
copy and paste the second device information to the response password entry box; and
when the connection button is triggered, generate the connection request based on the link and the second device information on the information exchange page, so as to establish the WebRTC connection between the first browser and the second browser.

In this embodiment, after returning the second device information, the called device 4 waits for the calling device 2 to initiate the connection request. The calling device 2 initiates the connection request if it is detected that the connection button is triggered. The called device 4 returns a connection response after receiving the connection request. The calling device 2 and the called device 4 successfully establish the WebRTC connection after a predetermined number of handshakes.

As an optional embodiment:
the calling device 2 is configured to: copy and paste the link on the information exchange page to the first application communication platform; and transmit the pasted link to the called device through the first application communication platform.

The called device 4 is configured to: obtain, through the first application communication platform, the link transmitted by the calling device, and copy and paste the link from the first application communication platform to an address bar of the browser.

In this embodiment, through copying and pasting, the first device information to be exchanged is transmitted to the called device 4 through the first application communication platform, so as to implement efficient exchange of the first device information and bypass a signaling server.

As an optional embodiment:
the called device 4 is configured to: copy and paste the second device information in the second browser to the second application communication platform, and transmit the pasted second device information to the calling device through the second application communication platform.

The calling device 2 is configured to: obtain the second device information through a second application communication platform, and copy and paste the second device information from the second application communication platform to the response password entry box.

In this embodiment, through copying and pasting, the second device information to be exchanged is transmitted to the calling device 2 through the second application communication platform, so as to implement efficient exchange of the second device information and bypass the signaling server.

Continue to refer to FIG. 2. The following provides a WebRTC connection process based on the foregoing WebRTC connection system.

The calling device 2 has the first browser, WeChat A, and Facebook A that are built in.

The called device 4 has the second browser, WeChat B, and Facebook B that are built in.

The WebRTC connection process is as follows.

In step 1, the first browser initiates an HTTP request packet to the CDN server that is deployed publicly.

In step 2, the CDN server returns an HTTP response packet in response to the HTTP request packet.

The HTTP response packet carries page information of an information exchange page, code that triggers obtaining of device information, and the like.

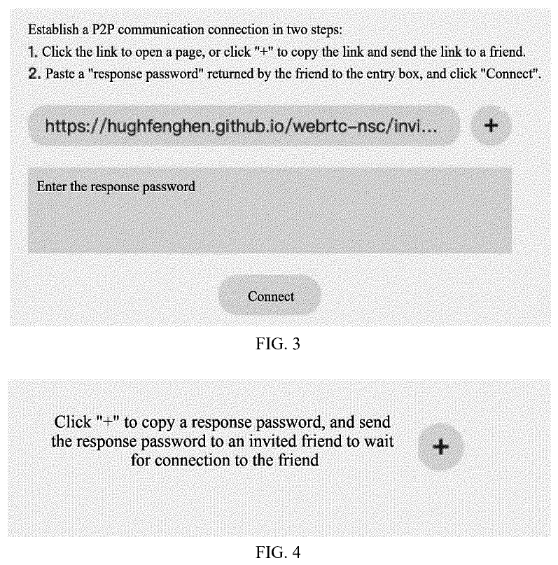

In step 3, the first browser receives the HTTP response packet, and displays the information exchange page carrying a link (as shown in FIG. 3).

The link may be a uniform resource locator (URL) link.

The HTTP response packet includes the page information and executable code.

The first browser performs the following operations based on the page information and the executable code:
(1) requesting first device information (for example, a public network address and a port number of the calling device 2) from the STUN server that is deployed publicly;
(2) generating the link based on the first device information;
(3) generating the information exchange page, the information exchange page including a link entry box, a response password entry box, and a connection button;
(4) entering the link in the link entry box; and
(5) displaying the information exchange page including the entered link.

In step 4, the link on the information exchange page is copied and pasted to WeChat A.

As shown in FIG. 3, a “+” control is further configured on the information exchange page to copy the link in the link entry box in a shortcut manner.

In step 5, the pasted link is sent to WeChat B through WeChat A.

In step 6, after WeChat B receives the link, the link in WeChat B is copied and pasted to an address bar of the second browser.

In step 7, the second browser opens the link, stores the first device information in the link, and requests second device information (for example, a public network address and a port number of the called device 4) from the STUN server that is deployed publicly.

In step 8, the second browser receives the second device information returned by the STUN server, and waits for the first browser to initiate a connection request.

The second device information may exist in a form of a response password.

The second browser may display the second device information or the response password of the second device information for copying and pasting.

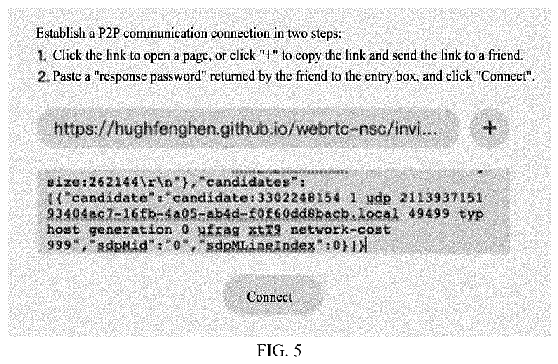

Alternatively, the second browser may hide the second device information or the response password of the second device information. As shown in FIG. 4, only the “+” control is provided in a pop-up layer to copy the second device information or the response password that is hidden.

In step 8, the second device information is copied and pasted to Facebook B.

In step 9, the pasted second device information is sent to Facebook A through Facebook B.

In step 10, after Facebook A receives the second device information, the second device information in Facebook A is copied and pasted to the response password entry box (as shown in FIG. 5).

In step 11, when the connection button is triggered, the first browser generates the connection request based on the link and the second device information on the information exchange page, so as to establish a WebRTC connection (that is, a WebRTC-protocol-based peer-to-peer connection) between the first browser and the second browser.

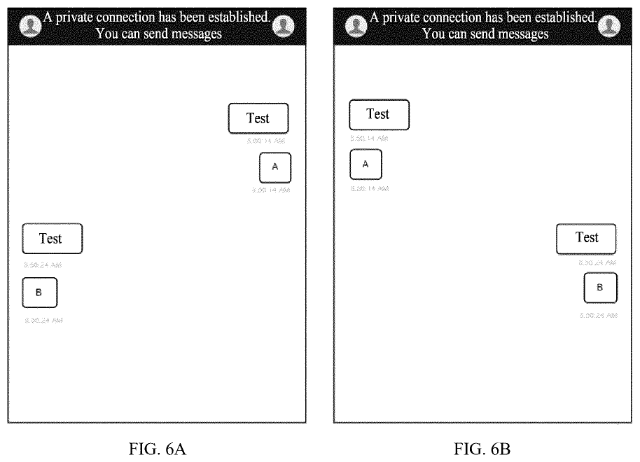

The calling device 2 and the called device 4 may implement communication based on the WebRTC connection (as shown in FIG. 6).

As described above, in the process of establishing the WebRTC connection, information exchange (for example, the first device information and the second device information) between the calling device 2 and the called device 4 is implemented through WeChat and Facebook. To be specific, information exchange between the two bypasses a (private) signaling server. Therefore, the WebRTC connection process is prevented from being recorded and tracked by the (private) signaling server, and privacy and security in WebRTC communication are ensured.

The first device information is transmitted through WeChat, and the second device information is transmitted through Facebook. Information exchange is performed in different communication modes, so that a complete information exchange process is prevented from being recorded by a same private service, and tracing difficulty is increased.

The CDN server that is deployed publicly and the STUN server that is deployed publicly are used, so that interception and tracking by the private service are further prevented. The CDN server that is deployed publicly uses an open source public page, so that there is no fear of interception, and the following problem is effectively solved: when a communication portal (for example, a specific web page or APP) is built by an enterprise or privately, and is not open and transparent to the public, information is intercepted and recorded before sent.

### Embodiment 2

A WebRTC connection method provided in this embodiment is applied to the calling device 2. For technical details, refer to the above.

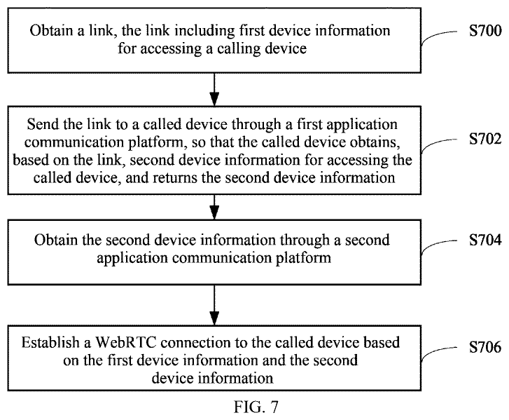

FIG. 7 is a flowchart schematically showing the WebRTC connection method according to Embodiment 2 of the present application.

As shown in FIG. 7, the WebRTC connection method may include steps S700 to S706.

In step S700, a link is obtained, the link including first device information for accessing the calling device.

In step S702, the link is sent to the called device through a first application communication platform, so that the called device obtains, in response to the link, second device information for accessing the called device, and returns the second device information.

In step S704, the second device information is obtained through a second application communication platform.

In step S706, a WebRTC connection is established to the called device based on the first device information and the second device information.

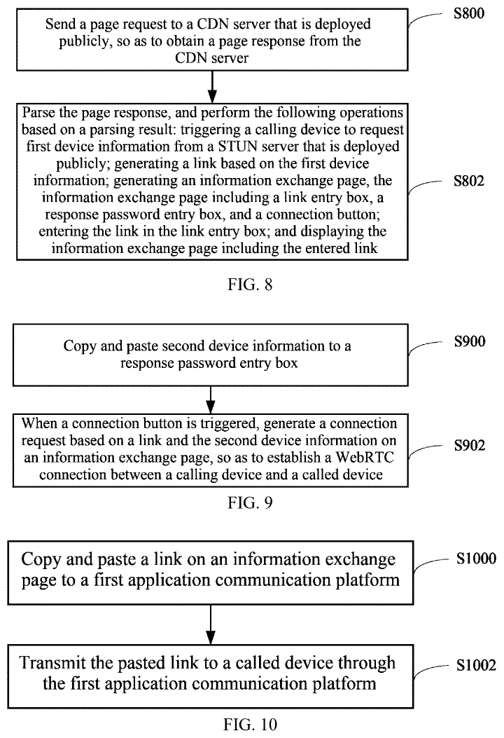

As an optional embodiment, as shown in FIG. 8, step S700 includes the following steps.

In step S800, a page request is sent to a CDN server that is deployed publicly, so as to obtain a page response from the CDN server.

In step S802, the page response is parsed, and the following operations are performed based on a parsing result:
triggering the calling device to request the first device information from the STUN server that is deployed publicly;
generating the link based on the first device information;
generating an information exchange page, the information exchange page including a link entry box, a response password entry box, and a connection button;
entering the link in the link entry box; and
displaying the information exchange page including the entered link.

As an optional embodiment, as shown in FIG. 9, step S706 includes the following steps.

In step S900, the second device information is copied and pasted to the response password entry box.

In step S902, when the connection button is triggered, a connection request is generated based on the link and the second device information on the information exchange page, so as to establish the WebRTC connection between the calling device and the called device.

As an optional embodiment, the first application communication platform is different from the second application communication platform.

As an optional embodiment, as shown in FIG. 10, step S702 includes the following steps.

In step S1000, the link on the information exchange page is copied and pasted to the first application communication platform.

In step S1002, the pasted link is transmitted to the called device through the first application communication platform.

As an optional embodiment, as shown in FIG. 11, step S704 includes the following steps.

In step S11000, the second device information transmitted by the called device is obtained through the second application communication platform.

In step S1102, the second device information is copied and pasted from the second application communication platform to the response password entry box.

### Embodiment 3

A WebRTC connection method provided in this embodiment is applied to the called device 4. For technical details, refer to the above.

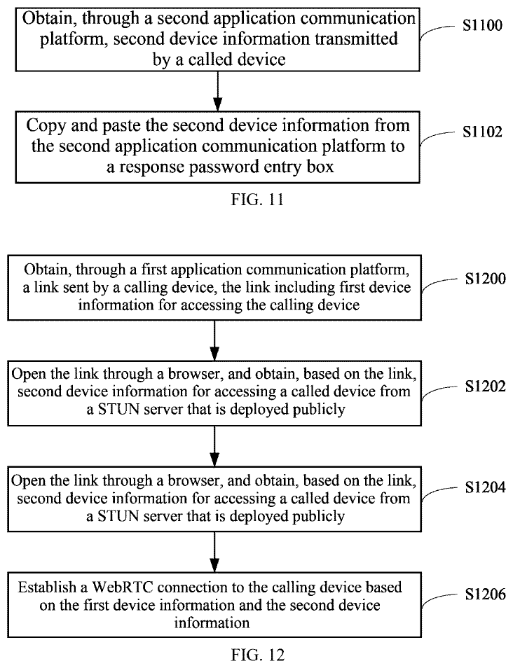

FIG. 12 is a flowchart schematically showing the WebRTC connection method according to Embodiment 3 of the present application.

As shown in FIG. 12, the WebRTC connection method may include steps S1200 to S1206.

In step S1200, a link sent by a calling device is obtained through a first application communication platform, the link including first device information for accessing the calling device.

In step S1202, the link is opened through a browser, and second device information for accessing the called device from the STUN server that is deployed publicly is obtained based on the link.

In step S1204, the second device information is sent to the calling device through a second application communication platform.

In step S1206, a WebRTC connection is established to the calling device based on the first device information and the second device information.

As an optional embodiment, the first application communication platform is different from the second application communication platform.

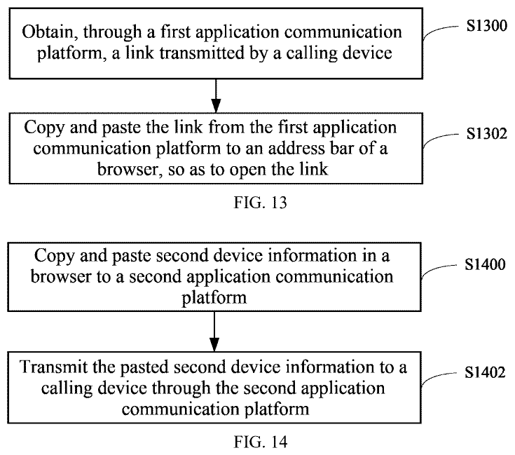

As an optional embodiment, as shown in FIG. 13, step S1200 includes the following steps.

In step S1300, the link transmitted by the calling device is obtained through the first application communication platform.

In step S1302, the link is copied and pasted from the first application communication platform to an address bar of the browser, so as to open the link.

As an optional embodiment, as shown in FIG. 14, step S1204 includes the following steps.

In step S1400, the second device information in the browser is copied and pasted to the second application communication platform.

In step S1402, the pasted second device information is transmitted to the calling device through the second application communication platform.

### Embodiment 4

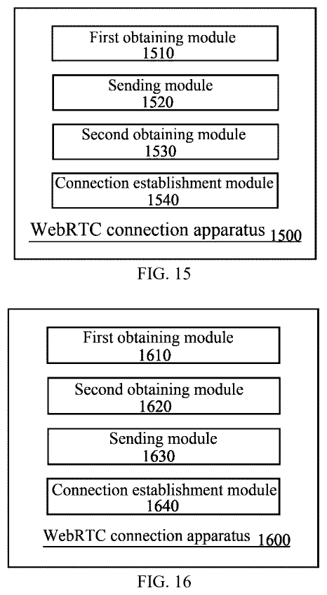

FIG. 15 is a block diagram schematically showing a WebRTC connection apparatus according to Embodiment 4 of the present application. The WebRTC connection apparatus is used in the calling device 2, and may be divided into one or more program modules, and the one or more program modules are stored in a storage medium and executed by one or more processors, to implement the embodiments of the present application. The program modules referred to in the embodiments of the present application refer to a series of computer-readable instruction segments capable of implementing a specific function. The functions of various program modules in the embodiments will be specifically described in the following descriptions.

As shown in FIG. 15, the WebRTC connection apparatus 1500 may include a first obtaining module 1510, a sending module 1520, a second obtaining module 1530, and a connection establishment module 1540.

The first obtaining module 1510 is configured to obtain a link, the link including first device information for accessing the calling device.

The sending module 1520 is configured to send the link to the called device through a first application communication platform, so that the called device obtains, in response to the link, second device information for accessing the called device, and returns the second device information.

The second obtaining module 1530 is configured to obtain the second device information through a second application communication platform.

The connection establishment module 1540 is configured to establish a WebRTC connection to the called device based on the first device information and the second device information.

As an optional embodiment, the first obtaining module 1510 is further configured to:
send a page request to a CDN server that is deployed publicly, so as to obtain a page response from the CDN server; and
parse the page response, and perform the following operations based on a parsing result:
   triggering the calling device to request the first device information from a STUN server that is deployed publicly;
   generating the link based on the first device information;
   generating an information exchange page, the information exchange page including a link entry box, a response password entry box, and a connection button;
   entering the link in the link entry box; and
   displaying the information exchange page including the entered link.

As an optional embodiment, the connection establishment module 1540 is further configured to:
copy and paste the second device information to the response password entry box; and
when the connection button is triggered, generate a connection request based on the link and the second device information on the information exchange page, so as to establish the WebRTC connection between the calling device and the called device.

As an optional embodiment, the first application communication platform is different from the second application communication platform.

As an optional embodiment, the sending module 1520 is further configured to:
copy and paste the link on the information exchange page to the first application communication platform; and
transmit the pasted link to the called device through the first application communication platform.

As an optional embodiment, the second obtaining module 1530 is further configured to:
obtain, through the second application communication platform, the second device information transmitted by the called device; and
copy and paste the second device information from the second application communication platform to the response password entry box.

### Embodiment 5

FIG. 16 is a block diagram schematically showing a WebRTC connection apparatus according to Embodiment 5 of the present application. The WebRTC connection apparatus is used in the called device 4, and may be divided into one or more program modules, and the one or more program modules are stored in a storage medium and executed by one or more processors, to implement the embodiments of the present application. The program modules referred to in the embodiments of the present application refer to a series of computer-readable instruction segments capable of implementing a specific function. The functions of various program modules in the embodiments will be specifically described in the following descriptions.

As shown in FIG. 16, the WebRTC connection apparatus 1600 may include a first obtaining module 1610, a second obtaining module 1620, a sending module 1630, and a connection establishment module 16540.

The first obtaining module 1610 is configured to obtain, through a first application communication platform, a link sent by the calling device, the link including first device information for accessing the calling device.

The second obtaining module 1620 is configured to open the link through a browser, and obtain, based on the link, second device information for accessing the called device from a STUN server that is deployed publicly.

The sending module 1630 is configured to send the second device information to the calling device through a second application communication platform.

The connection establishment module 1640 is configured to establish a WebRTC connection to the calling device based on the first device information and the second device information.

As an optional embodiment, the first application communication platform is different from the second application communication platform.

As an optional embodiment, the first obtaining module 1610 is further configured to:
obtain, through the first application communication platform, the link transmitted by the calling device; and
copy and paste the link from the first application communication platform to an address bar of the browser, so as to open the link.

As an optional embodiment, the sending module 1630 is further configured to:
copy and paste the second device information in the browser to the second application communication platform; and
transmit the pasted second device information to the calling device through the second application communication platform.

Embodiment 6

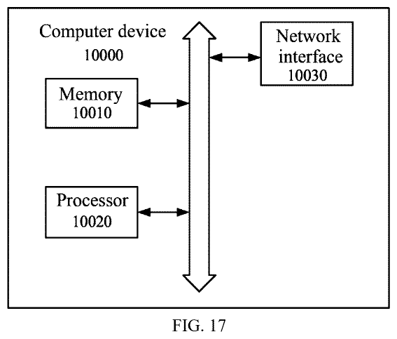

FIG. 17 is a schematic diagram schematically showing a hardware architecture of a computer device 10000 suitable for implementing a WebRTC connection method according to Embodiment 6 of the present application. In this embodiment, the computer device 10000 may be a device capable of automatically performing numerical calculation and/or information processing according to preset or prestored instructions. For example, the computer device may be various terminal devices such as a mobile device, a tablet device, a laptop computer, a smart television, a personal computer (PC), or a virtual reality device. As shown in FIG. 17, the computer device 10000 includes, but is not limited to a memory 10010, a processor 10020, and a network interface 10030 that may be communicatively linked to each other through a system bus.

The memory 10010 includes at least one type of computer-readable storage medium. The readable storage medium includes a flash memory, a hard disk, a multimedia card, a card-type memory (for example, an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the memory 10010 may be an internal storage module of the computer device 10000, for example, a hard disk or an internal memory of the computer device 10000. In some other embodiments, the memory 10010 may alternatively be an external storage device of the computer device 10000, for example, a plug-in hard disk, a smart media card (SMC for short), a secure digital (SD for short) card, or a flash card on the computer device 10000. Certainly, the memory 10010 may alternatively include both an internal storage module and an external storage device of the computer device 10000. In this embodiment, the memory 10010 is generally configured to store an operating system and various types of application software installed on the computer device 10000, such as program code for the WebRTC connection method. In addition, the memory 10010 may be further configured to temporarily store various types of data that have been output or are to be output.

In some embodiments, the processor 10020 may be a central processing unit (CPU for short), a controller, a microcontroller, a microprocessor, or another data processing chip. The processor 10020 is generally configured to control overall operation of the computer device 10000, for example, execute control, processing, and the like related to data interaction or communication with the computer device 10000. In this embodiment, the processor 10020 is configured to run program code stored in the memory 10010 or to process data.

The network interface 10030 may include a wireless network interface or a wired network interface. The network interface 10030 is generally configured to establish a communication link between the computer device 10000 and another computer device. For example, the network interface 10030 is configured to connect the computer device 10000 to an external terminal through a network, and establish a data transmission channel, a communication link, and the like between the computer device 10000 and the external terminal. The network may be a wireless or wired network, for example, Intranet, Internet, the Global System for Mobile Communications (GSM for short), wideband code division multiple access (WCDMA for short), a 4G network, a 5G network, Bluetooth, or Wi-Fi.

It should be noted that FIG. 17 shows only a computer device having components 10010 to 10030. However, it should be understood that not all of the shown components are required to be implemented, and more or fewer components may be implemented instead.

In this embodiment, the WebRTC connection method stored in the memory 10010 may alternatively be divided into one or more program modules and executed by one or more processors (the processor 10020 in this embodiment) to implement the embodiments of the present application.

### Embodiment 7

The present application further provides a computer-readable storage medium having computer-readable instructions stored thereon. When the computer-readable instructions are executed by a processor, the following steps are implemented:
obtaining a link, the link including first device information for accessing a calling device;
sending the link to a called device through a first application communication platform, so that the called device obtains, in response to the link, second device information for accessing the called device, and returns the second device information;
obtaining the second device information through a second application communication platform; and
establishing a WebRTC connection to the called device based on the first device information and the second device information.

Alternatively, when the computer-readable instructions are executed by a processor, the following steps are implemented:
obtaining, through a first application communication platform, a link sent by a calling device, the link including first device information for accessing the calling device;
opening the link through a browser, and obtaining, based on the link, second device information for accessing a called device from a STUN server that is deployed publicly;
sending the second device information to the calling device through a second application communication platform; and
establishing a WebRTC connection to the calling device based on the first device information and the second device information.

In this embodiment, the computer-readable storage medium includes a flash memory, a hard disk, a multimedia card, a card-type memory (for example, an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the computer-readable storage medium may be an internal storage unit of a computer device, for example, a hard disk or an internal memory of the computer device. In some other embodiments, the computer-readable storage medium may alternatively be an external storage device of a computer device, for example, a plug-in hard disk, a smart media card (SMC for short), a secure digital (SD for short) card, or a flash card on the computer device. Certainly, the computer-readable storage medium may alternatively include both an internal storage unit and an external storage device of a computer device. In this embodiment, the computer-readable storage medium is generally configured to store an operating system and various types of application software installed on the computer device, for example, program code for a WebRTC connection method in the embodiments. In addition, the computer-readable storage medium may be further configured to temporarily store various types of data that have been output or are to be output.

It is clear to those skilled in the art that the various modules or steps in the above embodiments of the present application may be implemented by a general-purpose computing apparatus, and may be centralized on a single computing apparatus or distributed on a network formed by a plurality of computing apparatuses. Optionally, the various modules or steps may be implemented by using program code executable by the computing apparatus, such that they may be stored in a storage apparatus and executed by the computing apparatus, and in some cases, the steps shown or described may be performed in a sequence different from that described herein, or they may be respectively fabricated into various integrated circuit modules, or a plurality of modules or steps thereof may be implemented as a single integrated circuit module. In this way, the embodiments of the present application are not limited to any specific combination of hardware and software.

It should be noted that the foregoing descriptions are merely preferred embodiments of the present application, and are not intended to limit the patent protection scope of the present application. Any transformation of equivalent structures or equivalent processes that is made using the contents of the description and accompanying drawings of the present application, or any direct or indirect application thereof in other related technical fields shall equally fall within the patent protection scope of the present application.

1. A method of implementing a Web real-time communication (WebRTC) connection, wherein the method is applied to a calling device, and the method comprises:
generating a link, wherein the link comprises first device-information for accessing the calling device;
sending the link to a called device through a first application communication platform, wherein the called device obtains, in response to the link, second information for accessing the called device;
obtaining the second information from the called device through a second application communication platform; and
establishing the WebRTC connection with the called device based on the first information and the second information.

2. The method according to claim 1, wherein the method further comprises:
sending a page request to a Content Delivery Network (CDN) server that is deployed publicly, and obtaining a page response from the CDN server; and
generating an information exchange page based on a result of parsing the page response, wherein the information exchange page comprises a link entry box, a response password entry box, and a connection button.

3. The method according to claim 2, wherein the establishing the WebRTC connection with the called device based on the first device-information and the second information comprises:
copying and pasting the second information to the response password entry box;
in response to detecting that the connection button is triggered, generating a connection request based on the link and the second information in the information exchange page, and establishing the WebRTC connection between the calling device and the called device.

4. The method according to claim 1, wherein the first application communication platform is different from the second application communication platform.

5. The method according to claim 2, wherein the sending the link to a called device through a first application communication platform comprises:
copying and pasting the link in the information exchange page to the first application communication platform; and
transmitting the pasted link to the called device through the first application communication platform.

6. The method according to claim 2, wherein the obtaining the second information through a second application communication platform comprises:
obtaining, through the second application communication platform, the second information transmitted from the called device; and
copying and pasting the second information from the second application communication platform to the response password entry box.

7. (canceled)

8. A method of implementing a Web real-time communication (WebRTC) connection, wherein the method is applied to a called device, and the method comprises:
obtaining a link sent from a calling device through a first application communication platform, wherein the link comprises first information for accessing the calling device;
opening the link through a browser, and obtaining second information for accessing the called device based on the link from a STUN server that is deployed publicly;
sending the second information to the calling device through a second application communication platform; and
establishing the WebRTC connection with the calling device based on the first information and the second information.

9. The method according to claim 8, wherein the first application communication platform is different from the second application communication platform.

10. The method according to claim 8, wherein the obtaining a link sent from a calling device through a first application communication platform comprises:
obtaining, through the first application communication platform, the link transmitted from the calling device; and
copying and pasting the link from the first application communication platform to an address bar of the browser, and opening the link.

11. The method according to claim 8, wherein the sending the second information to the calling device through a second application communication platform comprises:
copying and pasting the second information in the browser to the second application communication platform; and
transmitting the pasted second information to the calling device through the second application communication platform.

12. (canceled)

13. A computer device, comprising a memory, a processor, and computer-readable instructions stored on the memory and executable by the processor, wherein the computer-readable instructions upon execution by the processor cause the processor to implement operations comprising:
generating a link, wherein the link comprises first information for accessing the calling device;
sending the link to a called device through a first application communication platform, wherein the called device obtains, in response to the link, second information for accessing the called device;
obtaining the second information from the called device through a second application communication platform; and
establishing a Web real-time communication (WebRTC) connection with the called device based on the first information and the second information.

14-20. (canceled)

21. The method according to claim 1, wherein the generating the link further comprises:
requesting the first information from a Session Traversal Utilities for NAT (STUN) server that is deployed publicly; and
generating the link based on the first information.

22. The method according to claim 2, further comprising:
entering the link in the link entry box; and
displaying the information exchange page that comprises the entered link.

23. The computer device according to claim 13, wherein the generating the link further comprises:
requesting the first information from a Session Traversal Utilities for NAT (STUN) server that is deployed publicly; and
generating the link based on the first information.

24. The computer device according to claim 13, wherein the first application communication platform is different from the second application communication platform.

25. The computer device according to claim 13, the operations further comprising:
sending a page request to a Content Delivery Network (CDN) server that is deployed publicly, and obtaining a page response from the CDN server; and
generating an information exchange page based on a result of parsing the page response, wherein the information exchange page comprises a link entry box, a response password entry box, and a connection button.

26. The computer device according to claim 25, wherein the establishing the WebRTC connection with the called device based on the first information and the second information comprises:
copying and pasting the second information to the response password entry box;
in response to detecting that the connection button is triggered, generating a connection request based on the link and the second information in the information exchange page, and establishing the WebRTC connection between the calling device and the called device.

27. The computer device according to claim 25, wherein the sending the link to a called device through a first application communication platform comprises:
copying and pasting the link in the information exchange page to the first application communication platform; and
transmitting the pasted link to the called device through the first application communication platform.

28. The computer device according to claim 25, wherein the obtaining the second information through a second application communication platform comprises:
obtaining, through the second application communication platform, the second information transmitted from the called device; and
copying and pasting the second information from the second application communication platform to the response password entry box.

29. The computer device according to claim 25, the operations further comprising:
entering the link in the link entry box; and
displaying the information exchange page that comprises the entered link.
